(19) United States
(12) Patent Application Publication
(10) Pub. No.: US 2008/0268996 A1
(43) Pub. Date: Oct. 30, 2008

(54) SILENT CHAIN

(76) Inventors: Minoru Komada, Osaka (JP); Hitoshi Oohara, Osaka (JP); Takayuki Morimoto, Osaka (JP); Yoshinori Iwasaki, Osaka (JP); Syuuji Hamaguchi, Osaka (JP); Shouhei Adachi, Osaka (JP)

Correspondence Address: HOWSON AND HOWSON, SUITE 210, 501 OFFICE CENTER DRIVE, FT WASHINGTON, PA, 19034, US

(21) Appl. No.: 12/017,132

(22) Filed: Jan. 21, 2008

(30) Foreign Application Priority Data
Mar. 16, 2007 (JP) 2007-068161

(51) Int. Cl. F16G 13/06

(52) U.S. Cl. 474/213

(57) ABSTRACT

In a silent chain, a flank surface which comes into contact with a sprocket tooth at the start of engagement has a partially protruding portion continuously formed along the longitudinal direction of the flank surface. Only the partially protruding portions of link plates that initially contact the sprocket teeth are positively caused to wear during running in of the chain, so that protruding portions of flank surfaces of other link plates that did not initially contact the sprocket teeth are brought into contact with the sprocket teeth.

### FIELD OF THE INVENTION

This invention relates to silent chains, and more specifically to improvements in the design of the tooth flanks of the link plates of the chain that come into contact with sprocket teeth at the start of engagement of the chain with a sprocket.

### BACKGROUND OF THE INVENTION

A silent chain is generally formed of a plurality of link plates, each having a pair of pin holes and a pair of teeth having inner and outer flanks, the link plates being arranged in alternate, interleaved, joint link rows and guide link rows, and connecting pins extending through the pin holes and connecting the interleaved joint link rows and guide link rows to form an endless chain the teeth of which can be engaged with the teeth of a driving sprocket and one or more driven sprockets. A silent chain can be used in a variety of drive mechanisms, and is frequently used as a timing chain in an automobile engine, for transmitting power from a crankshaft sprocket to one or more sprockets fixed to intake and exhaust valve-operating camshafts.

Silent chains can exhibit several types of engagement, depending on the shapes of the teeth of the link plates. The two principal types of chain are the inner flank engagement/outer flank seating type, in which the inner flanks engage the sprocket teeth at the start of engagement, and the outer flank engagement/outer flank seating type, in which the outer flanks engage the sprocket teeth at the start of engagement.

In the inner flank engagement/outer flank seating type silent chain, when a tooth of each link plate engages with a sprocket tooth, an inner flank surface of a front tooth portion in an advancing direction of the link plate first comes into contact with a sprocket tooth, and slides toward a tooth gap bottom along the tooth surface of the sprocket tooth. During this sliding, the engagement shifts from the inner flank to the outer flank. The outer flank surfaces of a pair of teeth sequentially slide toward a tooth gap bottom along the sprocket teeth, and the pair of tooth portions engage with the sprocket teeth and seat thereon thereby to transmit power, as shown in FIG. 3 of the drawings.

In the outer flank engagement/outer flank seating type of silent chain, an outer flank of a rear tooth in an advancing direction of a link plate comes into engagement with a sprocket tooth, and continues its contact along the tooth surface until the completion of engagement. An outer flank surface of a front tooth portion also comes into contact with a sprocket tooth, and both outer flanks engage with sprocket teeth and seat thereon for transmission of power. This invention is applicable to the inner flank engagement/outer flank seating type silent chain, to the outer flank engagement/outer flank seating type silent chain, as well as to other silent chains have various types of engagement and seating sequences.

The link plates of a silent chain are conventionally produced by punching the pin holes, and the outer profiles of the link plates from hoop iron, steel plate and the like. However, since the shear plane ratio (i.e., the ratio of shear plane length to plate thickness) of the outer flank or the inner flank of a tooth, which comes into contact with a sprocket tooth at the time of starting engagement with the sprocket, is typically relatively small, it has been proposed, in U.S. Pat. No. 5,803,854, issued Sep. 8, 1998, to set the shear plane ratio to 90% or more by shaving and fine blanking, so that the contact area between a tooth of the link plate and a sprocket tooth is made larger, whereby wear of the sprocket teeth is reduced.

Link plate 31 in FIG. 9 is a conventional link plate, having outer flanks 34 and pin holes 35. FIG. 10 is a cross-sectional view in the direction of the arrows, taken on section plane X10-X10 in FIG. 9. When the shear plane ratio of the outer flank surface or the inner flank surface of a tooth is set to 90% or more, in for example, an inner flank engagement/outer flank seating type silent chain, in which the inner flank surface participates in the engagement with the sprocket tooth, as shown in FIGS. 9 and 10, an inner flank surface 33, which comes into contact with the sprocket tooth at the time of starting engagement of a tooth 32 of the link plate 31 with a sprocket tooth, is a substantially flat surface. Consequently, the contact area with the sprocket tooth is increased.

A conventional inner flank engagement/outer flank seating type silent chain, for example, can be formed so that the shear plane ratio of an inner flank surface 33 of tooth 32 is 90% or more, and plural link plates 31 are disposed in interleaved joint link rows and guide link rows and connected to each other by connecting pins. However, when this silent chain is engaged with sprockets to transmit power, inner flank surfaces 33 where the link plates of a row contact a sprocket tooth on starting of engagement, the flanks of these teeth are arranged in a flush relationship, as shown in FIG. 11. When teeth of the link plates start to engage with a sprocket, the inner flanks 33 are simultaneously brought into contact with a sprocket tooth 36. The resulting impact sound was large, causing a problem of an increased noise level during the operation of the chain.

Furthermore, even if the shear plane ratio of the inner flanks 33 of the individual link plates 31 is set to 90% or more, and the inner flanks 33 are arranged to be substantially flat as described above, the inner flanks 33 of the link plates 31 arranged in the chain width direction protrude unevenly and retract as shown in FIG. 12, as a result of manufacturing errors in the shapes of the parts, for example, errors in the outer profile shape or the pin hole shape.

When the link plates engage with the sprocket teeth 36 under the conditions depicted in FIG. 12, a link plate 31 whose inner flank surface 33 protrudes by the greatest distance receives a load. When the protrusion and retraction are small, the link plate 31 which first engages with a sprocket tooth, is elastically deformed. Then, when a next protruding inner flank 33 comes into contact with the sprocket tooth 36, a load is received by two link plates, so that the damage to each individual link plate is reduced. However, the link plates 31 collectively receive repeated loads due to engagement with a sprocket tooth 36.

When the protrusion and retraction distances are large, since the contact area of the inner flanks 33 of the link plates 31 is large and has a flat surface, does not wear rapidly. As a result, repeated loads resulting from engagement with the sprocket 36 are collectively received by a small number of link plates until their inner flanks 33, which first come into sliding contact with the sprocket teeth, wear, and the inner flanks 33 of other link plates 31 begin to come comes into contact with sprocket tooth.

When the inner flanks of the link plates arranged in the chain width direction are more or less uneven as described above, since the link plates having protruding inner flanks collectively receive repeated loads, excessive stress is generated, and the link plates tend to fracture, resulting in premature breakage of the chain. These problems are common in an outer flank engagement/outer flank seating type silent chain. Accordingly, an object of the invention is to solve the problems in conventional silent chains, and to provide a silent chain in which noises, which are generated at the start of engagement of a link plate tooth with a sprocket tooth, can be reduced; in which the noise level generated during operation of the chain can be reduced; and in which early fracture of the link plates is prevented, and premature breakage of the silent chain can be avoided.

### SUMMARY OF THE INVENTION

The silent chain according to the invention comprises a plurality of link plates, each having a pair of pin holes and a pair of teeth having inner and outer flanks. The link plates are arranged in alternate, interleaved, joint link rows and guide link rows, and connecting pins extend through the pin holes and connect the interleaved joint link rows and guide link rows to form a chain. The flank surfaces which come into contact with sprocket teeth at the start of engagement, have continuous protruding portions formed along a longitudinal direction of the flank surfaces. The protruding portion of each flank surface has a width, in the direction of the thickness of the link plate from which it protrudes, sufficiently small that the protruding portion is positively caused to wear upon initial running in of the chain, so that protruding portions of flank surfaces of other link plates that approach, but do not initially come into contact with, sprocket teeth, are brought into contact with sprocket teeth. The term “initial running in” refers to the operation of a new chain from its first use until unusual sounds generated in the operation of the chain disappear. In the case of a silent chain used as the timing chain in an automobile engine, the “initial running in” is the interval from the time when the automobile is first driven until it has been driven approximately 1000 kilometers.

In the silent chain of the invention, since only protruding portions that contact the sprocket teeth initially are positively caused to wear during the initial running in of the chain, the contact area of the protruding portion in a flank surface of a link plate tooth, which comes into contact with a sprocket tooth, is relatively small. Thus, reduction in noise generated at start of engagement between the link plate teeth and the sprocket teeth, and reduction in the noise level during the operation of the chain can be realized.

Furthermore, since only the protruding portions of link plates in contact with the sprocket teeth are positively caused to wear in the initial running in of the chain so that protruding portions of flank surfaces of other link plates that do not initially contact the sprocket teeth are brought into contact with the sprocket teeth, early fracture of link plates is prevented and premature breakage of the silent chain can be avoided.

### BRIEF DESCRIPTION OF THE DRAWINGS

FIG. 1 is a plan view of a part of a silent chain according to the invention;

FIG. 2 is an elevational view of a part of the silent chain;

FIG. 3 is an enlarged elevational view showing the engagement of a silent chain according to the invention with sprocket teeth;

FIG. 4 is an elevational view of a link plate of the silent chain;

FIG. 5 is a cross-sectional view of the link plate taken on the plane X5-X5 in FIG. 4;

FIG. 6 is a cross-sectional view showing contact between the link plate teeth of an uncompleted silent chain and a sprocket tooth;

FIG. 7 is a cross-sectional view showing contact between the link plate teeth of a completed silent chain and a sprocket tooth, taken on section plane X7-X7 in FIG. 3;

FIGS. 8(A) to 8(D) are cross-sectional views of link plates according to four modified embodiments of the invention;

FIG. 9 is an elevational view of a link plate of a conventional silent chain;

FIG. 10 is a cross-sectional view taken on section plane X10-X10 in FIG. 9;

FIG. 11 is a sectional view showing contact between a conventional silent chain and a sprocket tooth; and

FIG. 12 a sectional view showing contact between another conventional silent chain and a sprocket tooth.

### DETAILED DESCRIPTION OF THE PREFERRED EMBODIMENTS

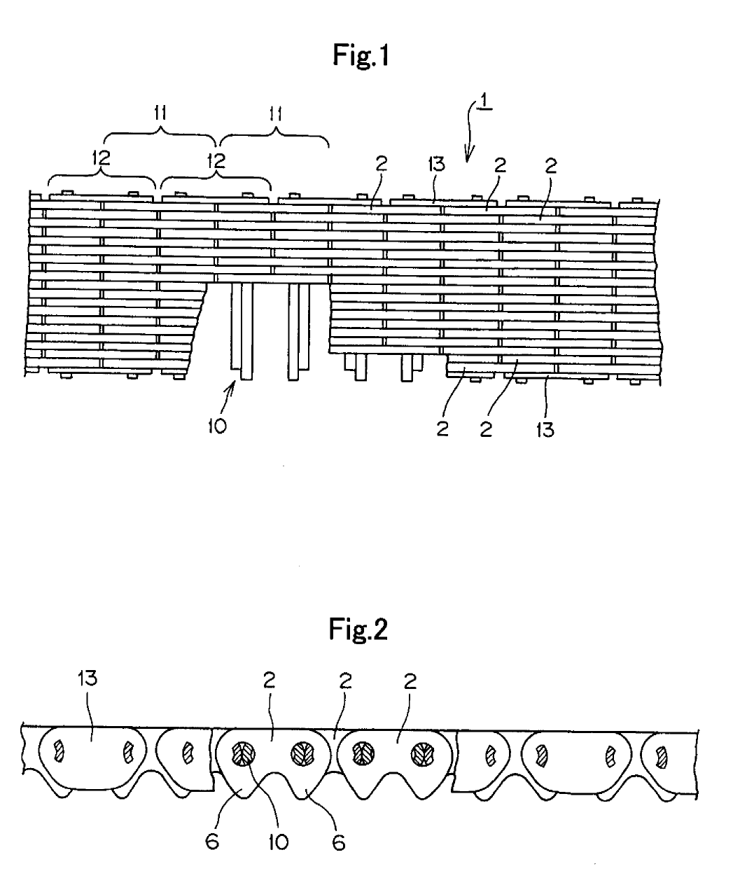

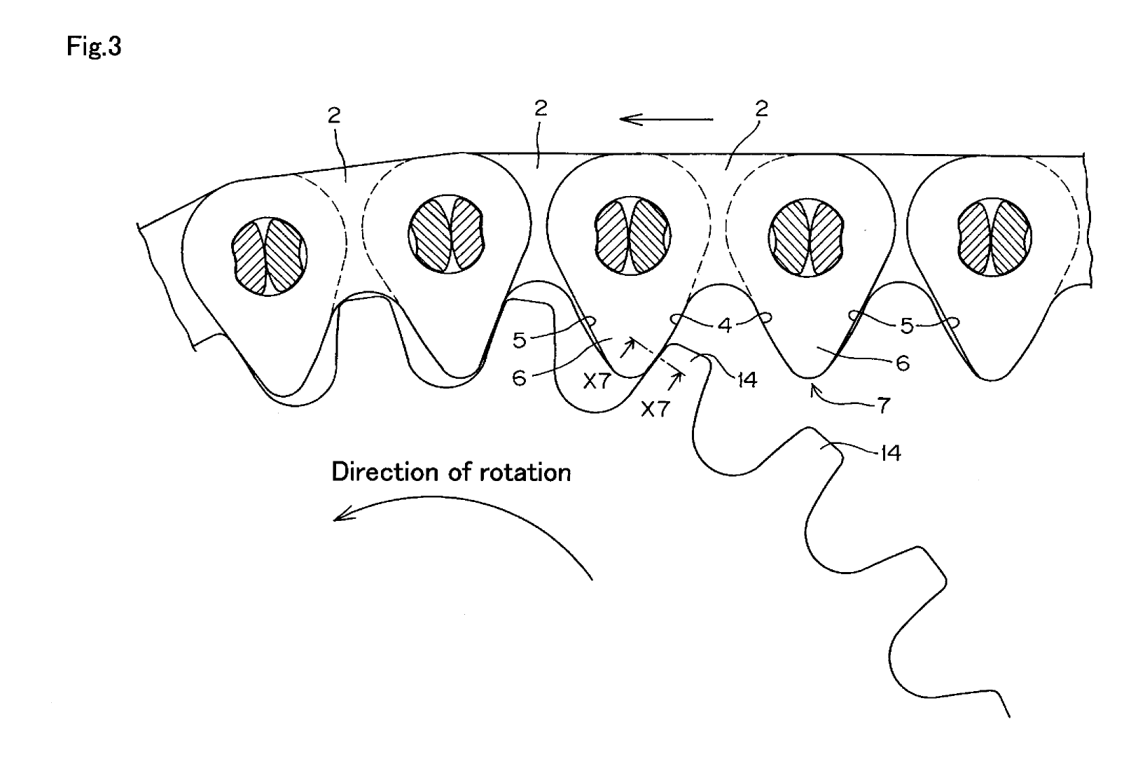

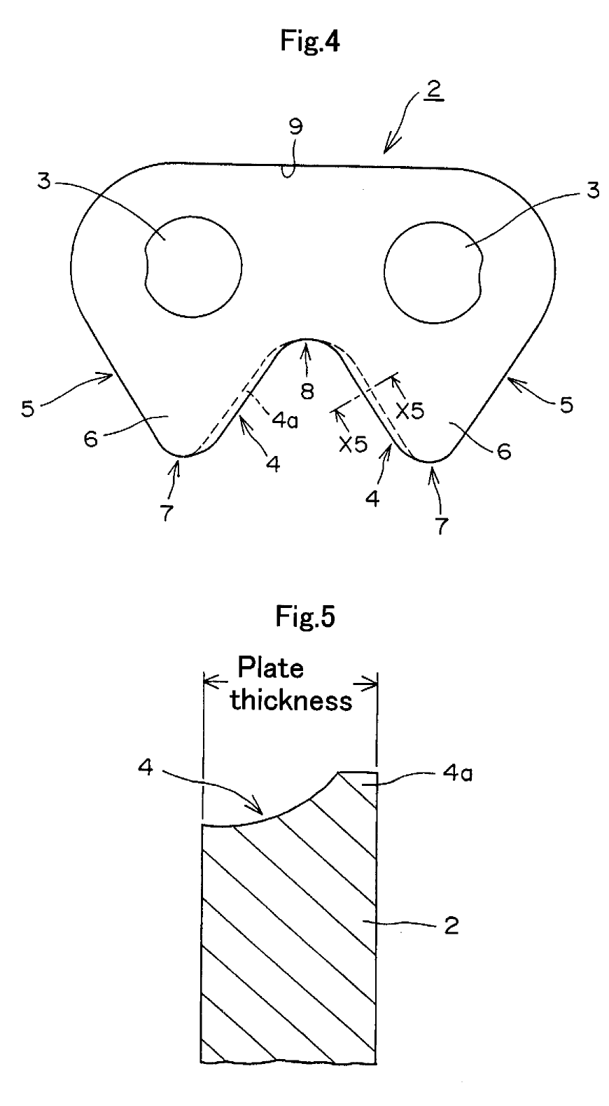

FIGS. 1 to 7 depict an inner flank engagement/outer flank seating type silent chain 1. As shown in FIG. 4, each of the link plates 2 forming the silent chain includes, a pair of pin holes 3 through which connecting pins 10 (FIGS. 2 and 3) are inserted, a pair of tooth portions 6, having inner flanks 4 and outer flanks 5, tooth heads 7, a crotch 8 and a back surface 9.

As shown in FIGS. 1 and 2, the silent chain 1 is formed so that a plurality of link plates 2 are arranged in joint link rows 11 and guide link rows 12 in the chain width direction, and link plates 2 in the respective adjacent rows 11 and 12 are interleaved, and are connected to by connecting pins 10 composed of long and short rocker joint pins. Guide plates 13 are arranged on both outermost sides of the guide link row. The joint link rows 11 and the guide link rows 12 can consist of individual plates spaced from one another, or may consist of spaced stacks of two or more plates. The individual plates may be interleaved, or the stacks of plates may be interleaved. The connecting pins may be rocket joint pins or round pins.

As shown in FIGS. 4 and 5, the link plate 2 has partially protruding portions 4a, each of which is continuously formed on a tooth flank surface. The protruding portions contact a sprocket tooth at the start of engagement with the sprocket tooth. The protruding portion 4a extends from a tooth head 7 to the crotch 8 of the link plate. When the link plates 2 are disposed in joint link rows 11 and guide link rows 12 to form an incomplete silent chain 1′ as shown in FIG. 5, the tops of the protruding portions 4a of the inner flank surfaces 4 of the link plates become uneven in the chain width direction due to errors in the shapes of the plates, and deflection of the connecting pins. Only the protruding portions 4a come into contact with the sprocket tooth 14.

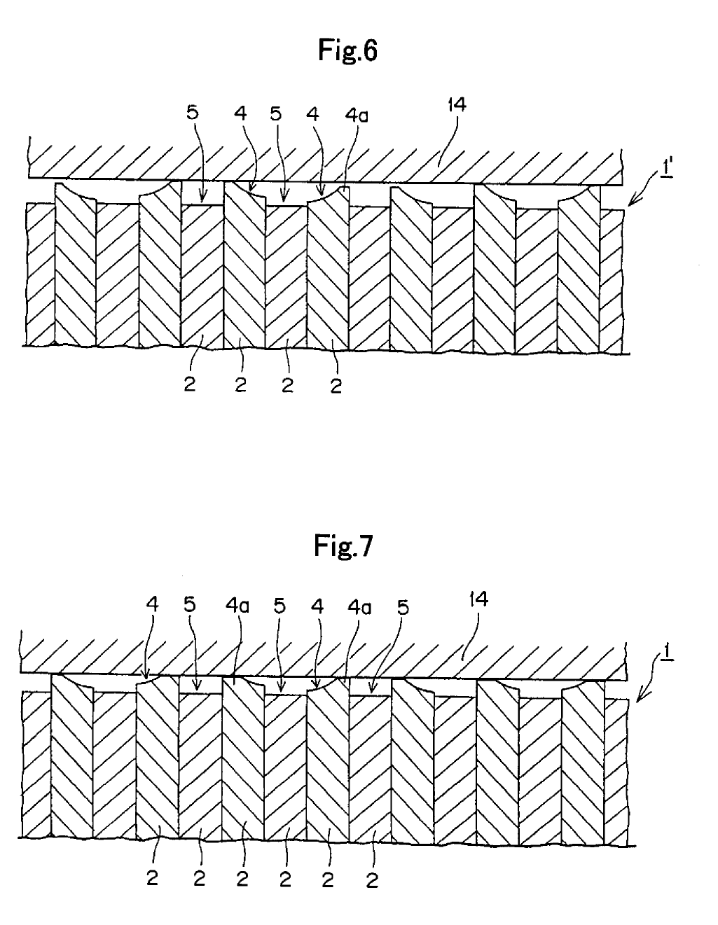

The incomplete silent chain 1′ is engaged with sprockets, and, as shown in FIG. 6, only the protruding portions 4a of some of the link plates 2 come into contact with the sprocket tooth 14. Initial wear of the protruding portions is positively caused by initial running in of the chain. Only the protruding portions 4a in contact with the sprocket tooth are caused to wear initially As a result, the protruding portions 4a of the other link plates not in contact with the sprocket tooth 14, are brought into contact with the sprocket tooth 14.

As shown in FIG. 7, in the silent chain 1 thus formed, protruding portions 4a of inner flank surfaces 4 of link plates 2 arranged in the chain width direction simultaneously come into contact with the sprocket tooth 14 at the start of engagement with the sprocket tooth 14. The outer flank surfaces 5 do not come into contact with the sprocket tooth 14.

The configuration of an inner flank engagement/outer flank seating type silent chain has been described above. The action and effects of the silent chain 1 will be described hereinbelow. In a case where the silent chain 1 is engaged with sprockets including a driving sprocket to transmit power, when the diving sprocket is rotated as shown in FIG. 3, inner flank surfaces 4 of the teeth of each link plate 2 come into sliding contact with sprocket teeth 14 at the start of engagement. Then, as the sprocket rotates, the engagement is shifted from the inner flanks 4 to the outer flanks 5, and the outer flanks 5 of the teeth 6 come into sliding contact with the sprocket teeth 14 so that teeth 6 of the link plate 2 are inserted between sprocket teeth 14 and seated thereon to transmit power.

An inner flank 4 of a front tooth in the advancing direction of the link plate 2 first comes into contact with a sprocket tooth 14 to start engagement with the sprocket tooth. However, since the contact area of the protruding portion 4a on the inner flank 4 of each link plate 2 is small, even if the protruding portions 4a in a joint link row 11 and a guide link row 12 simultaneously come into contact with the sprocket tooth 14, noises generated at the start of engagement between tooth portions 6 and the sprocket tooth 14 can be reduced.

Furthermore, since only the protruding portions 4a of the link plates 2 in contact with the sprocket tooth 14 are positively caused to wear during the initial running in of the chain so that protruding portions 4a of flank surfaces of other link plates, which were not in contact with the sprocket tooth 14, are brought into contact with the sprocket tooth, the protruding portions 4a of inner flank surfaces 4 of all the link plates 2 in the joint link rows 11 and the guide link rows 12 can be simultaneously brought into contact with the sprocket tooth 14. As a result, early fracture of the link plates 2 is prevented, and breakage of the silent chain 1 can be avoided. Thus, the strength of the silent chain is improved.

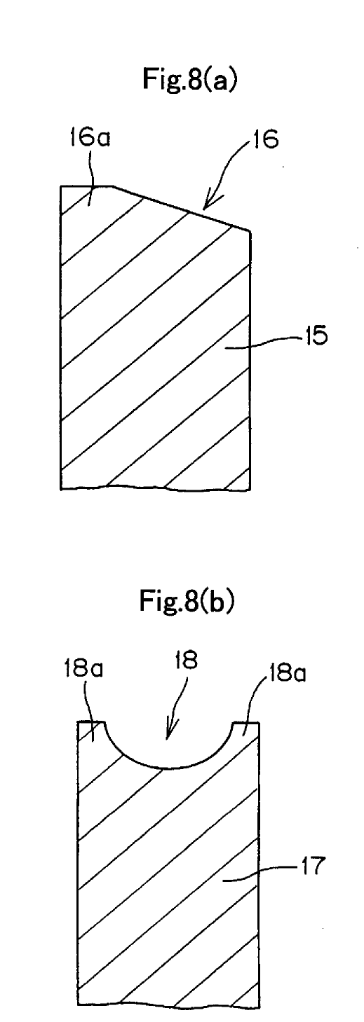

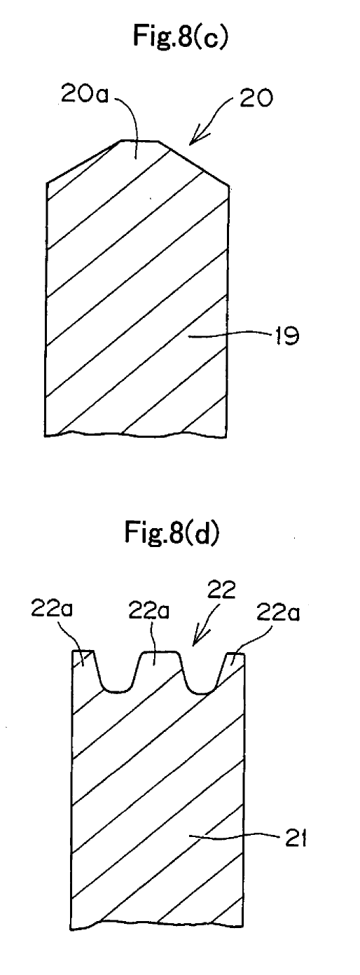

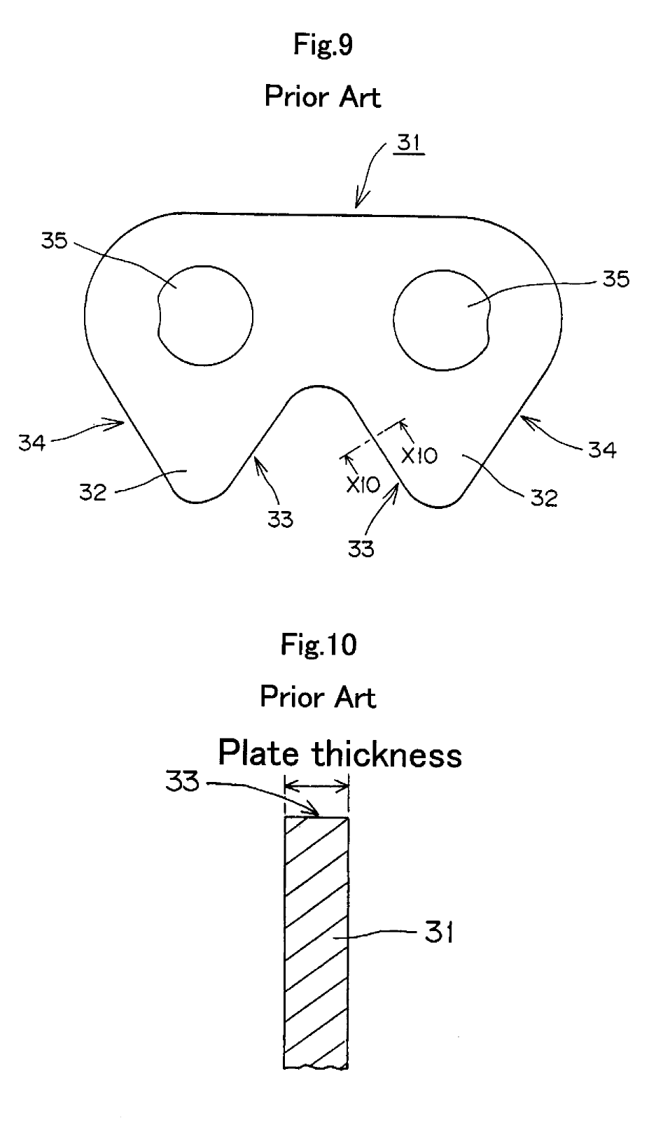

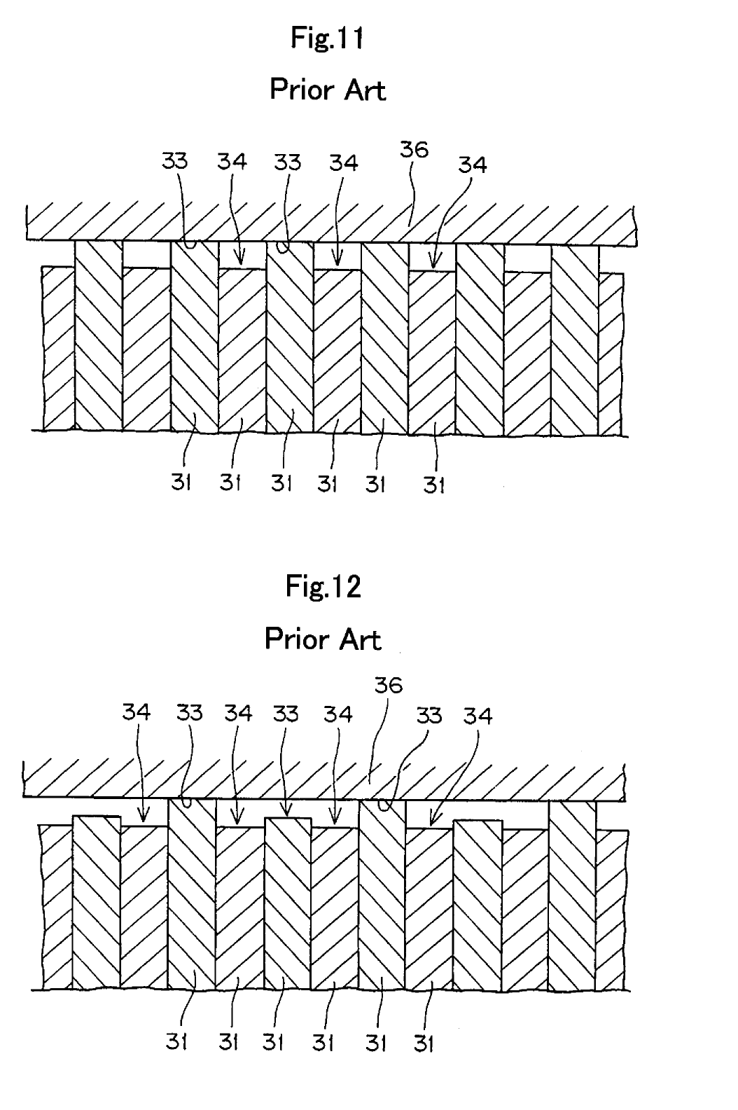

In modified examples of the silent chain, the shape of the protruding portion of the inner flank surface of a tooth of the link plate can be changed. Modified examples are shown in FIGS. 8(a) to 8(d). A link plate 15 in a modified example shown in FIG. 8(a) comprises a partially protruding portion 16a formed continuously on an inclined inner flank surface 16 of a tooth. A link plate 17 in a modified example shown in FIG. 8(b) has protruding portions 18a formed continuously on both sides of an inner flank surface 18. A link plate 19 in another modified example shown in FIG. 8(ci) has a central protruding portion 20a formed continuously on the inner flank surface 20 of the tooth. A link plate 21 in a fourth modified example shown in FIG. 8(d) has protruding portions 22a formed continuously on the center and sides of an inner flank surface 22 of the tooth portion.

In the above-described examples, an inner flank engagement/outer flank seating type silent chain 1 has protruding portions on the inner flanks of its tooth link plates which participate in engagement with a sprocket tooth, the invention can be embodied in an outer flank engagement/outer flank seating type silent chain. In the outer flank engagement/outer flank seating type silent chain, the surfaces which participates in engagement with a sprocket tooth 14 are only the outer flanks. The inner flank surfaces do not participate in engagement. Portions (not shown) common to the silent chain of the above-described example will be described with the same reference numerals for convenience.

In these silent chains, an outer flank surface 5, which comes into contact with a sprocket tooth 14 at the start of engagement, has a partially protruding portion corresponding in shape to protruding portion 4a of the above-described example, and protruding portions having the same shapes as protruding portions 16a, 18a, 20a and 22a of the modified examples. These protruding portions continuous from the tooth head 7 to the back surface 9 side in the longitudinal direction of the outer flank 5, and only the protruding portions, in the joint link rows 11 and guide link rows 12, that come into contact with the sprocket teeth 14 are caused to wear initially, so that protruding portions of other link plates, which did not initially contact the sprocket teeth 14, are brought into contact with the sprocket teeth.

The outer flank engagement/outer flank seating type silent chain exhibits the same action and effects as those exhibited by the inner flank engagement, outer flank seating type silent chain. However, in the link plates arranged in the joint link rows 11 and the guide link rows 12 in the chain width direction, since the contact area of the protruding portions formed in the outer flank surfaces is small, a reduction in the noise generated at the start of engagement, and an overall reduction in noise level during operation can be realized.

Since only the protruding portions of link plates, in contact with a sprocket tooth are positively caused to wear initially during the initial running in of the chain, protruding portions of other link plates that do not initially contact the sprocket tooth 14, are brought into contact with the sprocket tooth 14. Protruding portions of the outer flank surfaces 5 of all the link plates in the joint link rows 11 and the guide link rows 12 can be simultaneously brought into contact with the sprocket tooth 14. As a result, early fracture of link plates is prevented and breakage of the silent chain can be prevented. Thus, the strength of the silent chain can be improved.

We claim:

1. A silent chain comprising a plurality of link plates, each having a pair of pin holes and a pair of teeth having inner and outer flanks, the link plates being arranged in alternate, interleaved, joint link rows and guide link rows, and connecting pins extending through the pin holes and connecting the interleaved joint link rows and guide link rows to form a chain, in which the flank surfaces which come into contact with sprocket teeth at the start of engagement, have continuous protruding portions formed along a longitudinal direction of the flank surfaces, and the protruding portion of each said flank surface having a width, in the direction of the thickness of the link plate from which it protrudes, sufficiently small that said protruding portion is positively caused to wear upon initial running in of the chain so that protruding portions of flank surfaces of other link plates that approach, but do not initially come into contact with, sprocket teeth are brought into contact with sprocket teeth.
